(19) United States
(12) Patent Application Publication
(10) Pub. No.: US 2026/0003303 A1
(43) Pub. Date: Jan. 1, 2026

(54) PRINT HEAD AND IMAGE FORMING APPARATUS

(71) Applicant: SHARP KABUSHIKI KAISHA, Osaka (JP)

(72) Inventors: Yusuke TAKI, Osaka (JP); Akito TERAMOTO, Osaka (JP)

(21) Appl. No.: 19/243,030

(22) Filed: Jun. 19, 2025

(30) Foreign Application Priority Data
Jun. 26, 2024 (JP) 2024-102808

(51) Int. Cl. G03G 15/04; B41J 2/45

(52) U.S. Cl. CPC G03G 15/04054; B41J 2/451

(57) ABSTRACT

A print head includes a light-emitting element panel, a lens array, and a fixing member. A rib is provided on a surface (rear surface) of the fixing member constituted by a resin material. A plurality of light-emitting elements are provided on the light-emitting element panel such that none of light-emitting points overlaps rib regions, or at least two ribs are provided so as to intersect each other on the surface (rear surface) of the fixing member. The plurality of light-emitting elements are provided on the light-emitting element panel such that none of the light-emitting points overlaps an intersection region.

### BACKGROUND OF THE INVENTION

### Field of the Invention

This disclosure relates to a print head and an image forming apparatus such as a copier, a multifunction device, a printer, a facsimile device and the like.

### Description of the Background Art

The print head generally includes a light-emitting element mounting-member having a plurality of light-emitting elements aligned in a line state, a lens array that collects light emitted from the plurality of light-emitting elements on an image carrier (for example, a photosensitive drum), and a fixing member that fixes the light-emitting element mounting-member.

When the fixing member is made of a resin material, the fixing member needs to have a certain degree of strength so as not to be deformed. Therefore, the strength is ensured by providing a rib on the surface of the fixing member on a side opposite to the light-emitting element mounting-member side. However, due to the rib shape, a displacement spot (in particular, a recess spot or a so-called sink mark caused by the rib) is generated in a part corresponding to the rib on the surface on which the light-emitting element mounting-member of the fixing member is provided.

In this regard, in a case where a rigid light-emitting element board (glass board) is used as the light-emitting element mounting-member as in the print head (exposure head) described in a conventional technique, the light-emitting element board is less likely to be deformed in heat dissipation plate (fixing member).

However, when a film-like light-emitting element panel is used instead of a rigid light-emitting element board, following inconveniences occur.

FIG. 38 is a cross-sectional view illustrating a state in which a displacement spot 314e is generated in a part corresponding to a rib 314d of a front surface 314a of a fixing member 314 in which the rib 314d is provided on a rear surface 314b. FIG. 39 is a cross-sectional view illustrating a state in which a film-like light-emitting element panel 311 is deformed by the displacement spot 314e.

Since the film-like light-emitting element panel 311 has an extremely small thickness of approximately 0.14 mm, for example, and is closely attached (bonded) to the fixing member 314, when a displacement spot 314e (particularly, a sink mark) is generated by the rib shape in a spot corresponding to the rib 314d of the surface (front surface 314a) of the fixing member 314, on which the light-emitting element panel 311 is provided (see FIG. 38), the light-emitting element panel 311 is deformed (for example, waved) by the displacement spot 314e (see FIG. 39).

As shown in FIG. 38, when the light-emitting element panel 311 is deformed by the displacement spot 314e, as shown in FIG. 39, a positional relationship between the lens array 32 and spots of light-emitting points 31a to 31a of the light-emitting elements 31 to 31 corresponding to the displacement spot 314e among the plurality of light-emitting elements 31 in the light-emitting element panel 311 collapses (the focal distance with the lens array 32 is shifted) and thus, such a spot where a focus cannot be allowed at each image height is generated. Therefore, when the surface of the image carrier is irradiated with light emitted from the plurality of light-emitting elements 31 to 31, inconvenience such as a defective beam diameter on the surface of the image carrier or the like occurs.

Thus, an object of this disclosure is to provide a print head and an image forming apparatus capable of effectively preventing occurrence of inconvenience such as the defective beam diameter on the surface of the image carrier or the like, when the surface of the image carrier is irradiated with light emitted by a plurality of light-emitting elements.

### SUMMARY OF THE INVENTION

This disclosure provides a print head and an image forming apparatus according to a first aspect and a second aspect described below in order to solve the above-described problems.

### (1) Print Head of First Aspect

A print head according to a first aspect of this disclosure is a print head characterized by including: a film-like light-emitting element panel having a plurality of light-emitting elements aligned in a line state; a lens array that collects light emitted from the plurality of light-emitting elements onto an image carrier; and a fixing member that fixes the light-emitting element panel, in which the fixing member is constituted by a resin material, a rib is provided on a surface on a side opposite to the light-emitting element panel side of the fixing member, and the plurality of light-emitting elements are provided on the light-emitting element panel such that each light-emitting point does not overlap a rib region corresponding to the rib.

### (2) Print Head of Second Aspect

A print head of a second aspect according to this disclosure is a print head characterized by including: a film-like light-emitting element panel having a plurality of light-emitting elements aligned in a line state; a lens array that collects light emitted from the plurality of light-emitting elements onto an image carrier; and a fixing member that fixes the light-emitting element panel, in which the fixing member is made of a resin material, at least two ribs are provided on a side opposite to the light-emitting element panel side of the fixing member so as to intersect each other, and the plurality of light-emitting elements are provided on the light-emitting element panel so that each light-emitting point does not overlap an intersection region corresponding to an intersection where the at least two ribs intersect each other.

### (3) Image Forming Apparatus

An image forming apparatus according to this disclosure is characterized by including a print head of the first aspect or the second aspect according to this disclosure.

According to this disclosure, occurrence of inconvenience such as a defective beam diameter on a surface of an image carrier or the like can be effectively prevented, when the surface of the image carrier is irradiated with light emitted by a plurality of light-emitting elements.

### BRIEF DESCRIPTION OF THE DRAWINGS

FIG. 1 is a cross-sectional view illustrating an image forming apparatus according to an Embodiment.

FIG. 2 is a perspective view illustrating a state in which an example of a print head in the image forming apparatus according to the Embodiment is provided on a main-body frame, as viewed obliquely from above on a front-surface side.

FIG. 3 is a perspective view of the print head shown in FIG. 2, which is supported by an installation member as viewed obliquely from above on the front-surface side.

FIG. 4 is a perspective view of the print head as viewed obliquely from above on a rear-surface side.

FIG. 5 is a perspective view of the print head illustrated in FIG. 4 as viewed obliquely from below on the front-surface side.

FIG. 6 is an exploded perspective view of the print head shown in FIG. 4 as viewed obliquely from above on the front-surface side.

FIG. 7 is an exploded perspective view of the print head shown in FIG. 4 as viewed obliquely from below on the rear-surface side.

FIG. 8 is a cross-sectional perspective view of the print head as viewed obliquely from above on the front-surface side.

FIG. 9 is a cross-sectional view of the print head.

FIG. 10 is a schematic diagram illustrating the cross-sectional view shown in FIG. 9 so as to be understood easily.

FIG. 11 is a plan view illustrating a state in which a flexible circuit board is extended linearly in a light-emitting element panel, the flexible circuit board, and a printed wiring board constituting the print head.

FIG. 12 is a perspective view for explaining an example of a first process of a manufacturing process of the print head.

FIG. 13 is a perspective view for explaining an example of a second process of the manufacturing process of the print head.

FIG. 14 is a perspective view for explaining an example of a third process of the manufacturing process of the print head.

FIG. 15 is a perspective view for explaining an example of a fourth process of the manufacturing process of the print head.

FIG. 16 is a perspective view for explaining an example of a fifth process of the manufacturing process of the print head.

FIG. 17 is a perspective view for explaining an example of a sixth process of the manufacturing process of the print head.

FIG. 18 is a perspective view illustrating a state in which a light-emitting element panel is provided on a fixing member.

FIG. 19 is a perspective view illustrating the fixing member.

FIG. 20 is a perspective view illustrating a rib of a first aspect provided on a rear surface of the fixing member.

FIG. 21 is a perspective view illustrating a rib of a second aspect provided on the rear surface of the fixing member.

FIG. 22 is a perspective view illustrating a rib of a third aspect provided on the rear surface of the fixing member.

FIG. 23 is a perspective view illustrating a rib of a fourth aspect provided on the rear surface of the fixing member.

FIG. 24 is a plan view illustrating a positional relationship of a first comparative example between the rib of the first aspect shown in FIG. 20 and a plurality of light-emitting elements.

FIG. 25 is a bottom view illustrating a positional relationship of the first comparative example between the rib of the first aspect shown in FIG. 20 and the plurality of light-emitting elements.

FIG. 26 is a plan view illustrating a positional relationship of a second comparative example between a rib of a third aspect shown in FIG. 22 and the plurality of light-emitting elements.

FIG. 27 is a bottom view illustrating a positional relationship of the second comparative example between the rib of the third aspect shown in FIG. 22 and the plurality of light-emitting elements.

FIG. 28 is a plan view illustrating a positional relationship of a third comparative example between a rib of a fourth aspect shown in FIG. 23 and the plurality of light-emitting elements.

FIG. 29 is a bottom view illustrating a positional relationship of the third comparative example between the rib of the fourth aspect shown in FIG. 23 and the plurality of light-emitting elements.

FIG. 30 is a plan view illustrating a positional relationship of a First Embodiment-1 between the rib of the first aspect shown in FIG. 20 and the plurality of light-emitting elements.

FIG. 31 is a bottom view illustrating a positional relationship of the First Embodiment-1 between the rib of the first aspect shown in FIG. 20 and the plurality of light-emitting elements.

FIG. 32 is a plan view illustrating a positional relationship of a First Embodiment-2 between the rib of the second aspect shown in FIG. 21 and the plurality of light-emitting elements.

FIG. 33 is a bottom view illustrating a positional relationship of the First Embodiment-2 between the rib of the second aspect shown in FIG. 21 and the plurality of light-emitting elements.

FIG. 34 is a plan view illustrating a positional relationship of a Second Embodiment-1 between the rib and the plurality of light-emitting elements, in which a position of an intersection is shifted to one side in a width direction in the third aspect shown in FIG. 22.

FIG. 35 is a bottom view illustrating the positional relationship of the Second Embodiment-1 between the rib and the plurality of light-emitting elements, in which a position of an intersection is shifted to either one of sides in the width direction in the third aspect shown in FIG. 22.

FIG. 36 is a plan view illustrating a positional relationship of a Second Embodiment-2 between the rib and the plurality of light-emitting elements, in which a position of an intersection is shifted to either one of sides in a width direction in the fourth aspect shown in FIG. 23.

FIG. 37 is a bottom view illustrating a positional relationship of a Second Embodiment-2 between the rib and the plurality of light-emitting elements, in which a position of an intersection is shifted to either one of the sides in the width direction in the fourth aspect shown in FIG. 23.

FIG. 38 is a cross-sectional view illustrating a state in which a displacement spot is generated in a spot corresponding to a rib on a front surface of a fixing member in which the rib is provided on a rear surface.

FIG. 39 is a cross-sectional view illustrating a state in which a film-like light-emitting element panel is deformed by the displacement spot.

### DESCRIPTION OF THE PREFERRED EMBODIMENTS

Hereinafter, Embodiments according to this disclosure will be described with reference to the drawings. In the following explanation, same components are denoted by same reference signs. The names and functions thereof are also identical. Therefore, detailed explanation thereof will not be repeated.

### Image Forming Apparatus

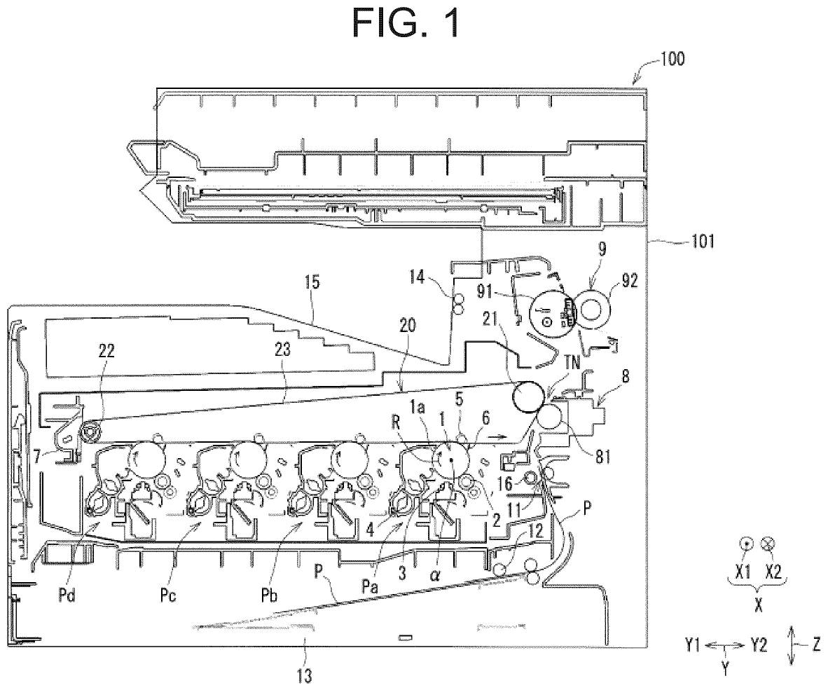

FIG. 1 is a cross-sectional view illustrating an image forming apparatus 100 according to this Embodiment. Note that the explanation will be given below in such a way that, in the drawings, X is a rotational axis direction of a photosensitive drum 1, X1 is a front-surface side, X2 is a rear-surface side, Y is a left-right direction perpendicular to the rotational axis direction X, Y1 is a right side, Y2 is a left side, and Z is an up-down direction perpendicular to the rotational axis direction X and the left-right direction Y.

Image data handled in an image forming apparatus main-body 101 of the image forming apparatus 100 corresponds to a color image using each color of black (K), cyan (C), magenta (M), and yellow (Y) or corresponds to a monochrome image using a single color (for example, black). Thus, four each of the photosensitive drums 1 (image carriers), chargers 2, print heads 3, developing devices 4, primary transfer devices 5, and drum cleaning devices 6 are provided to form four types of toner images corresponding to each color, and four image stations Pa, Pb, Pc, and Pd are provided, each corresponding to black, cyan, magenta, and yellow. Note that the image forming apparatus 100 may be a monochrome image forming apparatus.

In each of the image stations Pa, Pb, Pc, and Pd, the chargers 2 to 2 uniformly charge surfaces 1a of the photosensitive drums 1 to 1, which are rotationally driven in a predetermined rotational direction R, to a predetermined potential. The print heads 3 to 3 expose the surfaces 1a of the photosensitive drums 1 to 1 and form electrostatic latent images on the surfaces 1a of the photosensitive drums 1 to 1. The developing device 4 develops the electrostatic latent images on the surfaces 1a of the photosensitive drums 1 to 1 and forms a toner image on the surfaces 1a of the photosensitive drums 1 to 1. As a result, the toner image in each color is formed on a surface 1a of each of the photosensitive drums 1 to 1. The drum cleaning devices 6 to 6 remove and collect residual toner from the surfaces 1a of the photosensitive drums 1 to 1. The primary transfer devices 5 to 5 sequentially superimpose and transfer the toner image of each color on the surface 1a of each of the photosensitive drums 1 to 1 onto an intermediate transfer belt 23 circularly moved by a driving roller 21 and a driven roller 22 in a belt drive device 20 and form a color toner image on the intermediate transfer belt 23. The belt cleaning device 7 removes and collects the residual toner on the intermediate transfer belt 23.

A transfer nip spot TN is formed between the intermediate transfer belt 23 and a transfer roller 81 of a secondary transfer device 8. The transfer roller 81 of the secondary transfer device 8 transfers the color toner image on the surface of the intermediate transfer belt 23 onto a sheet P while sandwiching the sheet P such as a recording sheet conveyed through a sheet conveyance path 11 in the transfer nip spot TN and conveying the sheet P together with the intermediate transfer belt 23. A fixing device 9 sandwiches the sheet P between a fixing member (a fixing belt 91 in this example) and a pressure member (a pressure roller 92 in this example) and applies heat and pressure to fix the color toner image on the sheet P.

The sheet P is pulled out of a sheet feeding cassette 13 by a pickup roller 12, conveyed through the sheet conveyance path 11, passes through the secondary transfer device 8 and the fixing device 9, and is discharged to a discharge tray 15 via a discharge roller 14. In the sheet conveyance path 11, a resist roller 16 and the like are disposed. The resist roller 16 temporarily stops the sheet P, aligns the leading edge of the sheet P and then, starts conveyance of the sheet P in accordance with timing that transfers the toner image at the transfer nip spot TN between the intermediate transfer belt 23 and the transfer roller 81.

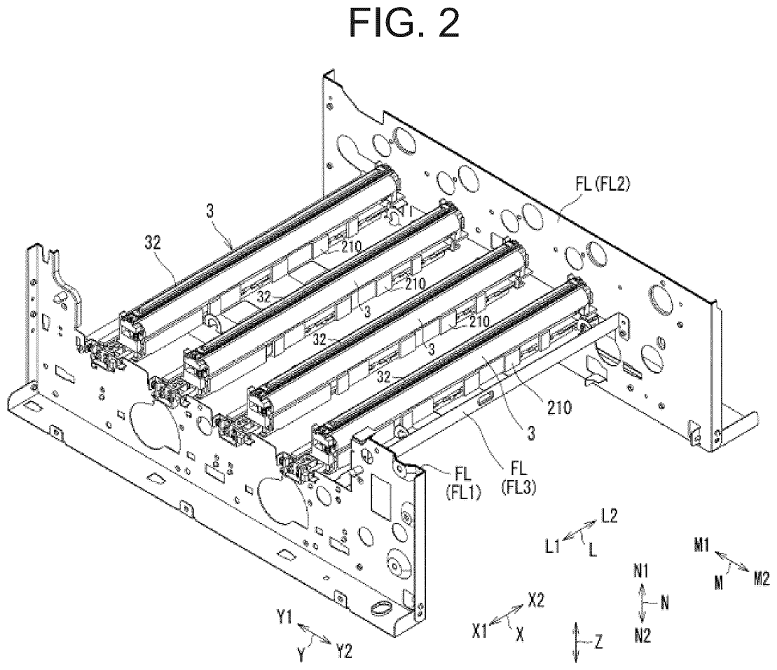

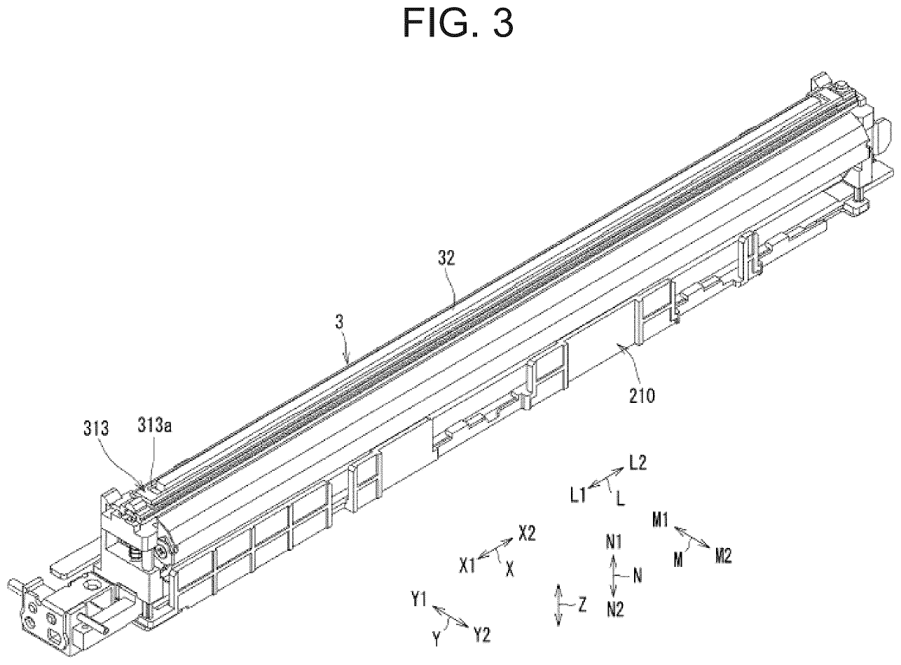

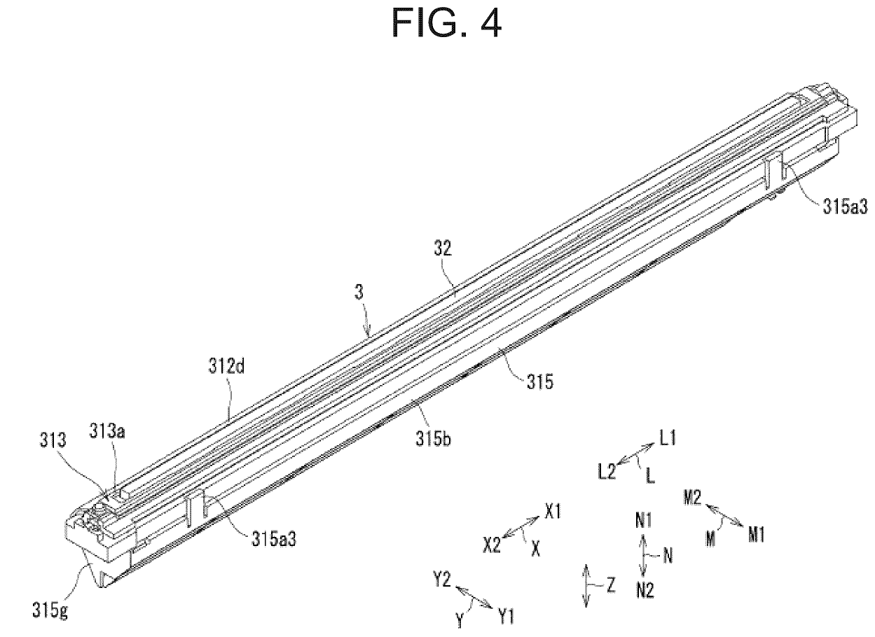

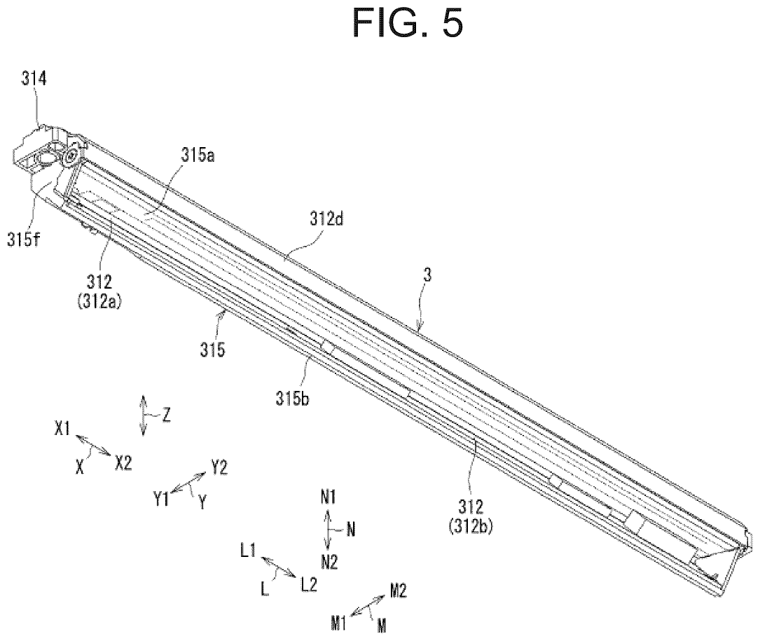

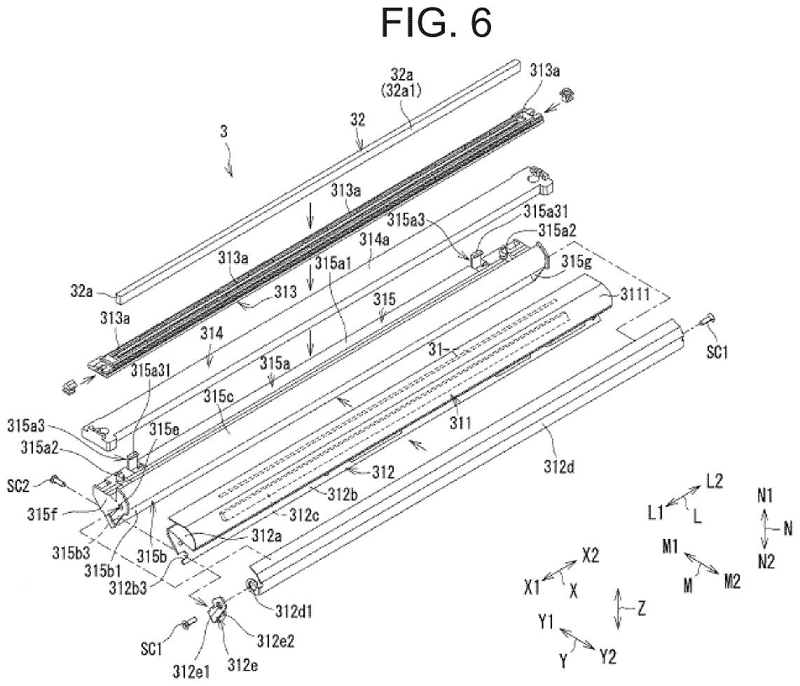

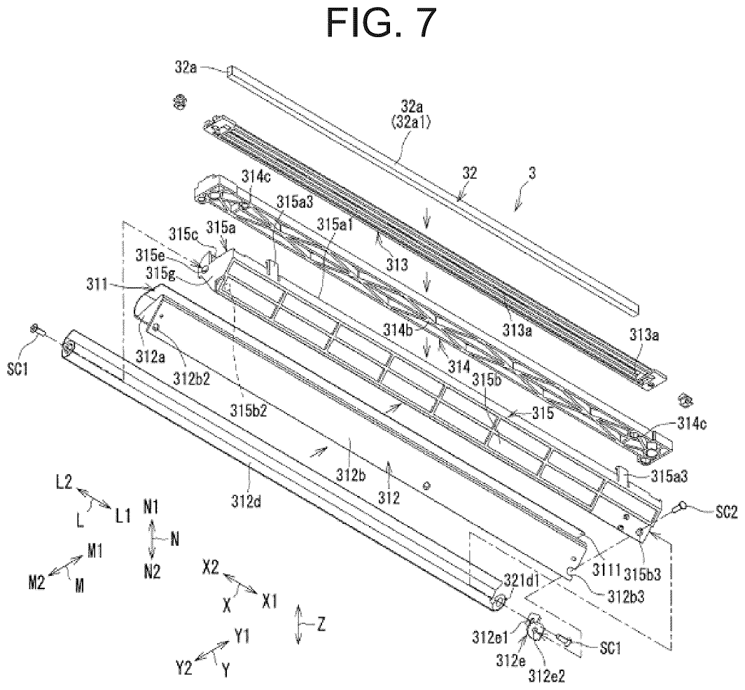

FIG. 2 is a perspective view of a state in which an example of the print heads 3 to 3 in the image forming apparatus 100 according to this Embodiment is provided on main-body frames FL (FL1 to FL3), as viewed from obliquely above on a front-surface side X1. FIG. 3 is a perspective view of a state in which the print head 3 shown in FIG. 2 is supported by an installation member 210, as viewed obliquely from above on the front-surface side X1. FIG. 4 is a perspective view of the print head 3 as viewed obliquely from above on the rear-surface side X2. FIG. 5 is a perspective view of the print head 3 shown in FIG. 4 as viewed obliquely from below on the front-surface side X1. FIG. 6 and FIG. 7 are exploded perspective views of the print head 3 shown in FIG. 4, as viewed obliquely from above on the front-surface side X1 and obliquely from below on the rear-surface side X2, respectively.

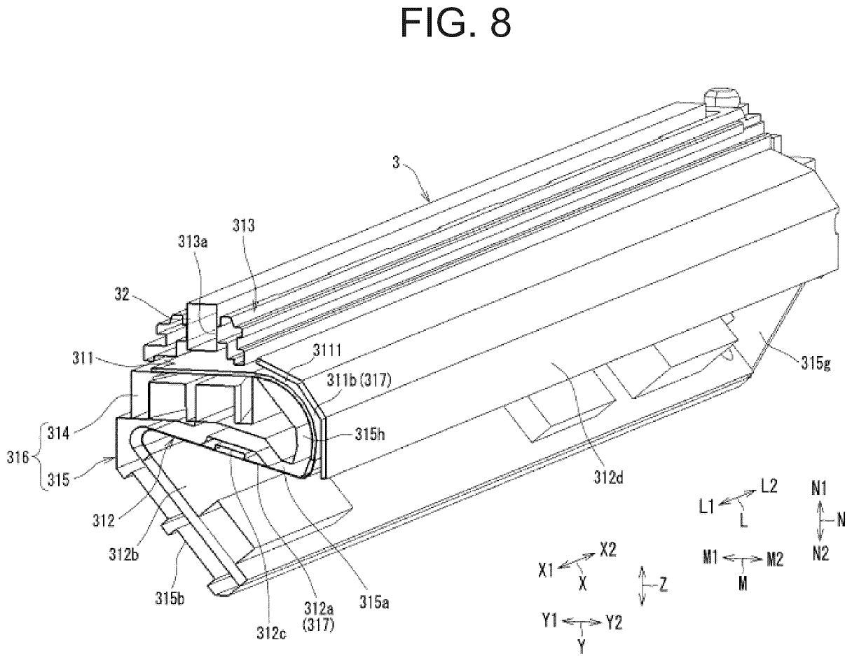

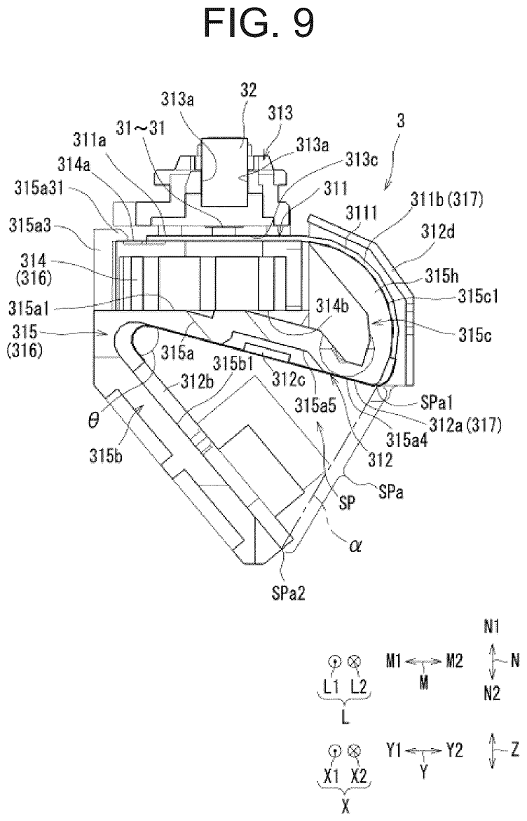

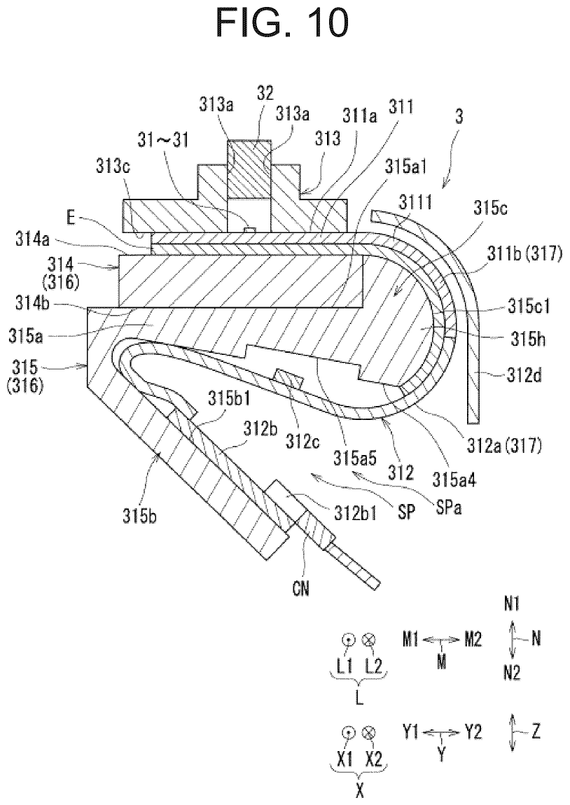

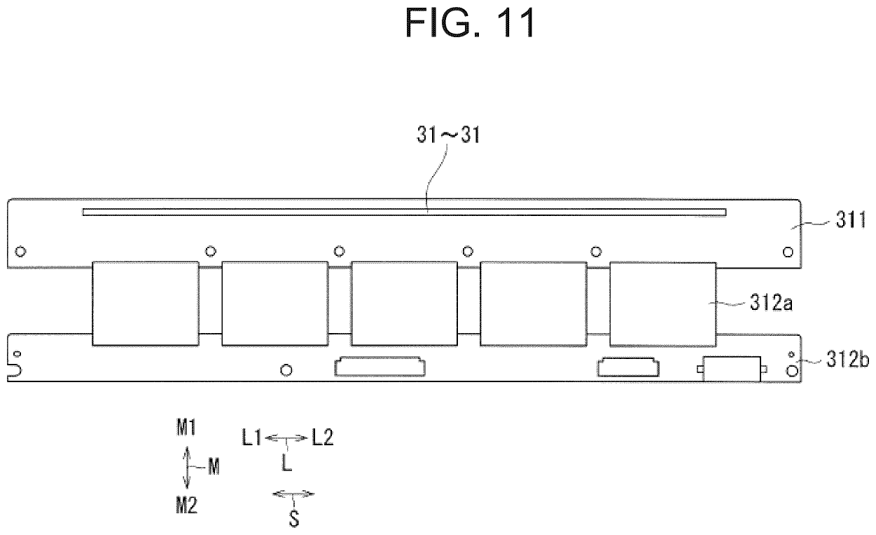

FIG. 8 is a cross-sectional perspective view of the print head 3 as viewed obliquely from above on the front-surface side. FIG. 9 is a cross-sectional view of the print head 3. FIG. 10 is a schematic diagram illustrating the cross-sectional view shown in FIG. 9 so as to be understood easily. FIG. 11 is a plan view illustrating a state in which, in the light-emitting element panel 311, a flexible circuit board 312a, and a printed wiring board 312b constituting the print head 3, the flexible circuit board 312a is extended in a linear state.

In the following explanation, the plurality of light-emitting elements 31 to 31 in the print heads 3 to 3 will be explained as organic EL diodes (OLED: Organic Light-Emitting Diode, hereinafter simply referred to as OLEDs). Note that the light-emitting elements 31 to 31 are not limited to the OLEDs, but may be light-emitting elements such as inorganic light-emitting diodes (LED) or nano-light-emitting diodes (nanoscale light-emitting diodes), which are light-emitting diodes (LED) having a size smaller than a micrometer, for example.

Note that, since each of the print heads 3 to 3 and the like has the same configuration, they are shown in one drawing in FIG. 3 to FIG. 11, and in the following explanation, each of the print heads 3 to 3 and the like is simply referred to as the print head 3 or the like.

The image forming apparatus 100 according to this Embodiment includes the photosensitive drum 1 and the lengthy print head 3. The print head 3 includes the light-emitting element panel 311 and the lens array 32. The light-emitting element panel 311 includes the plurality of light-emitting elements 31 to 31 (see FIG. 9 to FIG. 11). The light-emitting elements 31 to 31 emit light that exposes the surface 1a of the photosensitive drum 1. The light-emitting elements 31 to 31 are aligned in a line state and provided in parallel in a longitudinal direction L of the print head 3. In this example, the light-emitting element panel 311 is a film-like panel (flexible OLED panel) (light-emitting element panel) on which the OLED elements (31 to 31) are mounted. This makes it possible to make the print head 3 smaller and less expensive.

The lens array 32 extends in the longitudinal direction L and collects light emitted by the light-emitting elements 31 to 31 onto the surface 1a of the photosensitive drum 1. The lens array 32 is disposed so as to face the light-emitting elements 31 to 31.

The print head 3 is provided on the installation member 210. The installation member 210 is installed between the main-body frames FL of the image forming apparatus main-body 101 (see FIG. 1) (in this example, between the main-body frame FL1 on the front-surface side X1 and the main-body frame FL2 on the rear-surface side X2).

In this example, between the main-body frames FL1 and FL2, it is installed on a main-body frame FL3 along the rotational axis direction X and the left-right direction Y. The installation member 210 is placed on the main-body frame FL3.

### Print Head

As shown in FIG. 8 to FIG. 11, the print head 3 further includes a drive member 312, a lens holding member 313, a fixing member 314 (base member), and a main-body member 315. The fixing member 314 and the main-body member 315 constitute a support member 316. The drive member 312 drives the light-emitting elements 31 to 31. The lens holding member 313 holds the lens array 32. The fixing member 314 fixes the lens holding member 313 in a state where the light-emitting element panel 311 is fixed. The main-body member 315 holds the drive member 312, the lens holding member 313, and the fixing member 314.

In this example, the drive member 312 includes the flexible circuit board 312a (connection cable member), the printed wiring board 312b (PWB: Printed Wiring Board) (connection board), a drive circuit element 312c, and a protective member 312d. One end part of the connection-cable member (312a) is coupled to one end part of the light-emitting element panel 311, and the other end part thereof is coupled to one end part of the printed wiring board 312b. The connection cable member (312a) is a flexible circuit board (COF: Chip on Film) in which the drive circuit elements 312c (driver ICs) that drives the OLED elements (31 to 31) on the light-emitting element panel 311 are mounted on a film. The printed wiring board 312b coupled to the connection cable member (312a) has an input terminal 312b1 (see FIG. 10) (connector terminal) and is coupled to a connector CN (see FIG. 10) via the input terminal 312b1. The protective member 312d protects exposed parts of the light-emitting element panel 311 and the connection cable member (312a). The connector CN is connected to an image processing device (not shown) provided in the image forming apparatus main-body 101. Note that, in FIG. 10, it is described such that the light-emitting elements 31 to 31 are provided so as to protrude from an outer surface of the light-emitting element panel 311, but this is for easy understanding of the light-emitting elements 31 to 31, and in actuality, as shown in FIG. 9, they are provided (for example, vapor-deposited) on an inner side so as not to protrude from the outer surface of the light-emitting element panel 311.

The lens holding member 313 is a frame-shaped member surrounding outer peripheral surfaces 32a to 32a (see FIG. 6 and FIG. 7) of the lens array 32 along an optical axis direction N of the light-emitting elements 31 to 31. Here, the optical axis direction Nis a direction (thickness direction) orthogonal to both the longitudinal direction L and a width direction M of the print head 3. The width direction M is a direction orthogonal to an alignment direction S along a line-like direction of the plurality of light-emitting elements 31 to 31. The lens array 32 is inserted into an inner side surface 313a of the lens holding member 313, which is a frame-shaped member. In the lens array 32, at least some of the outer peripheral surfaces 32a to 32a (in this example, side surfaces 32a1, 32a1 along the longitudinal direction L) are held by the lens holding member 313 and are bonded by an adhesive (for example, an ultraviolet curable adhesive) in at least some spots (in this example, a plurality of spots). In addition, a periphery of a bonding spot between the lens array 32 and the lens holding member 313 is sealed with a caulking agent (caulking resin). As a result, entry of a foreign substance such as dust into the lens holding member 313 from the bonding spot between the lens array 32 and the lens holding member 313 can be effectively prevented.

The fixing member 314 is formed in a rectangular parallelepiped shape. To the front surface 314a on a photosensitive drum 1 side (one side N1) in the optical axis direction N of the fixing member 314, a rear surface on the side opposite to the light-emitting elements 31 to 31 of the light-emitting element panel 311 provided with the light-emitting elements 31 to 31 is bonded by an adhesive member E (for example, a double-sided adhesive tape) (see FIG. 10). To a panel surface 311a on the side opposite to the fixing member 314 of the light-emitting element panel 311, a rear surface 313c of the lens holding member 313 is fixed. The periphery of the bonding spot between the lens holding member 313 and the light-emitting element panel 311 is sealed with a caulking agent (caulking resin). As a result, the entry of the foreign substance such as dust into the lens holding member 313 from the bonding spot between the lens holding member 313 and the light-emitting element panel 311 can be effectively prevented.

Note that, relative positions (positions in the longitudinal direction L, the width direction M, and the optical axis direction N) of the plurality of light-emitting elements 31 to 31 and the lens array 32 are positioned and adjusted in advance by using a jig or the like in a production process.

The main-body member 315 has a disposition spot 315a, a bent spot 315b, and a panel guide 315c. The disposition spot 315a, the bent spot 315b, and the panel guide 315c are integrally formed.

The disposition spot 315a disposes the fixing member 314. The disposition spot 315a is provided with a disposition surface 315a1 on which the fixing member 314 is disposed so that the rear surface 314b of the fixing member 314 on the installation member 210 side is brought into contact. As a result, it is possible to reliably dispose the fixing member 314 on the disposition surface 315a1 of the disposition spot 315a. A plurality of (two) positioning protrusions or recesses (positioning protrusions 315a2 and 315a2 in this example) (see FIG. 6) are provided on the disposition surface 315a1 of the disposition spot 315a. On the rear surface 314b of the fixing member 314, positioning recesses or protrusions (in this example, positioning recesses 314c, 314c) (see FIG. 7) corresponding to the plurality of (two) positioning protrusions or recesses (315a2, 315a2) are provided. As a result, the fixing member 314 can be reliably positioned with respect to the main-body member 315. In addition, on the disposition spot 315a, a plurality of (two) holders 315a3, 315a3 (see FIG. 6, FIG. 7, and FIG. 9) are provided. The disposition spot 315a and the holders 315a3 and 315a3 are integrally formed. The holders 315a3, 315a3 detachably hold the fixing member 314 on the disposition spot 315a. The holders 315a3, 315a3 restrict movement of the fixing member 314 toward the light-emitting elements 31 to 31 side in the optical axis direction N (one side N1). The holders 315a3, 315a3 have a locker 315a31 (see FIG. 9) that locks the front surface 314a of the fixing member 314.

The bent spot 315b is bent at an acute angle (for example, 60 degrees or less, approximately 50 degrees in this example) with respect to the disposition spot 315a. The printed wiring board 312b is fixed to an opposing surface 315b1 (inner side surface) of the bent spot 315b facing the disposition spot 315a. The input terminal 312b1 is provided at an end part on an inlet side (opening SPa side) of a space SP between the disposition spot 315a and the bent spot 315b of the printed wiring board 312b, and the connector CN is connected toward the space SP.

The panel guide 315c has a curved area 315c1 that folds back a film-like protrusion 317 from the support member 316 (314, 315) toward the space SP. The curved area 315c1 is curved so as to fold back the lens holding member 313 side of the protrusion 317 (between the light-emitting element panel 311 and the connection cable member (312a) in this example) by 180 degrees or more. The curved area 315c1 protrudes to one side (in this example, the other side M2) in the width direction M from the lens holding member 313. To the curved area 315cl, a panel part 311b on the side of the connection cable member (312a) of the light-emitting element panel 311 and a part on the light-emitting element panel 311 side of the connection cable member (312a) are bonded by the adhesive member E. As a result, the curved area 315c1 can reliably fold back the protrusion 317 (the connection cable member (312a) in this example) into the space SP. The protective member 312d faces a part corresponding to the curved area 315c1 of the protrusion 317 and is curved along the curved area 315c1. As illustrated in FIG. 6 and FIG. 7, regarding the protective member 312d, a fastening member SC1 (male screw) is inserted through a through hole 312e1 of a holding tool 312e and a through hole 312d1 of the protective member 312d on one side L1 in the longitudinal direction L so that the protective member 312d is fastened to a fastened area 315e (female screw) of the main-body member 315. As a result, the end part on the one side L1 in the longitudinal direction L of the protective member 312d can be fixed to the main-body member 315.

In addition, the protective member 312d is fastened to the fastened area 315e of the main-body member 315 on the other side L2 in the longitudinal direction L, by inserting the fastening member SC1 through the through hole 312d1 of the protective member 312d. As a result, the end part of the protective member 312d on the other side L2 in the longitudinal direction L can be fixed to the main-body member 315. In addition, regarding the printed wiring board 312b, a positioning hole 312b2 of the printed wiring board 312b is positioned by a positioning protrusion 315b2 of the bent spot 315b on the other side L2 in the longitudinal direction L. In this state, regarding the printed wiring board 312b, the fastening member SC2 (male screw) is inserted through the through hole 315b3 of the bent spot 315b and a through recess 312b3 of the printed wiring board 312b on the one side L1 in the longitudinal direction L so that the printed wiring board 312b is fastened to a fastened area 312e2 (female screw) of the holding tool 312e. As a result, the protective member 312d can be held in a state of being positioned at the bent spot 315b.

An end part of a part [connection cable member (312a)] of the protrusion 317 provided in the space SP on the printed wiring board 312b side is folded back at a corner part between the disposition spot 315a and the bent spot 315b and is connected to the printed wiring board 312b.

The drive circuit element 312c is provided on the disposition spot 315a side of the connection cable member (312a). On an opposing surface 315a4 (inner side surface) of the disposition spot 315a facing the bent spot 315b, a recess 315a5 that prevents interference with the drive circuit element 312c in the connection cable member (312a) is provided.

In addition, the main-body member 315 is provided with a pair of side plate portions 315f, 315g (see FIG. 6 and FIG. 7), which close both ends in the longitudinal direction L of the space SP.

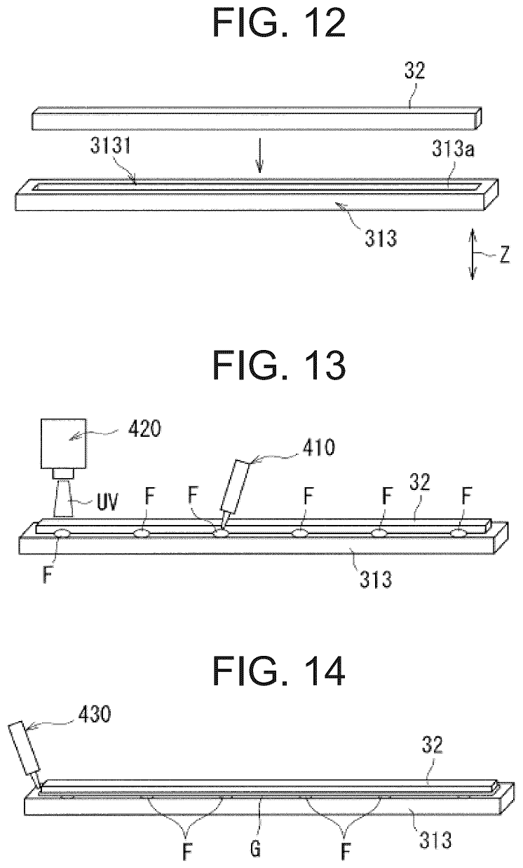

Subsequently, a method of manufacturing the print head 3 will be explained below with reference to FIG. 12 to FIG. 17.

FIG. 12 to FIG. 17 are perspective views illustrating an example of first to sixth processes of the manufacturing process of the print head 3, respectively. Note that FIG. 12 to FIG. 17 illustrate the processes of providing the lens array 32 on the lens holding member 313, providing the light-emitting element panel 311 on the fixing member 314, and providing the lens holding member 313 on the light-emitting element panel 311.

In the method of manufacturing the print head 3, first, as shown in FIG. 12, the lens array 32 is inserted into the inner side surface (313a) of the lens holding member 313 (in this example, a long through-hole 3131 along the vertical direction Z) (first process).

Subsequently, as shown in FIG. 13, after uniformly applying the ultraviolet curing adhesive F to a plurality of locations in the peripheral region between the lens array 32 and the lens holding member 313 using a dispenser 410, the ultraviolet curing adhesive F is cured by irradiating the ultraviolet curing adhesive F with ultraviolet rays UV using an ultraviolet irradiation device 420 (second process). As a result, the lens array 32 can be reliably held by the lens holding member 313.

Subsequently, as shown in FIG. 14, a caulking agent G (caulking resin) is applied to the peripheral region between the lens array 32 and the lens holding member 313 using a caulking-agent application device 430 to seal the gap between the lens array 32 and the lens holding member 313 (third process). As a result, entry of a foreign substance such as dust through a gap between the lens array 32 and the lens holding member 313 can be prevented.

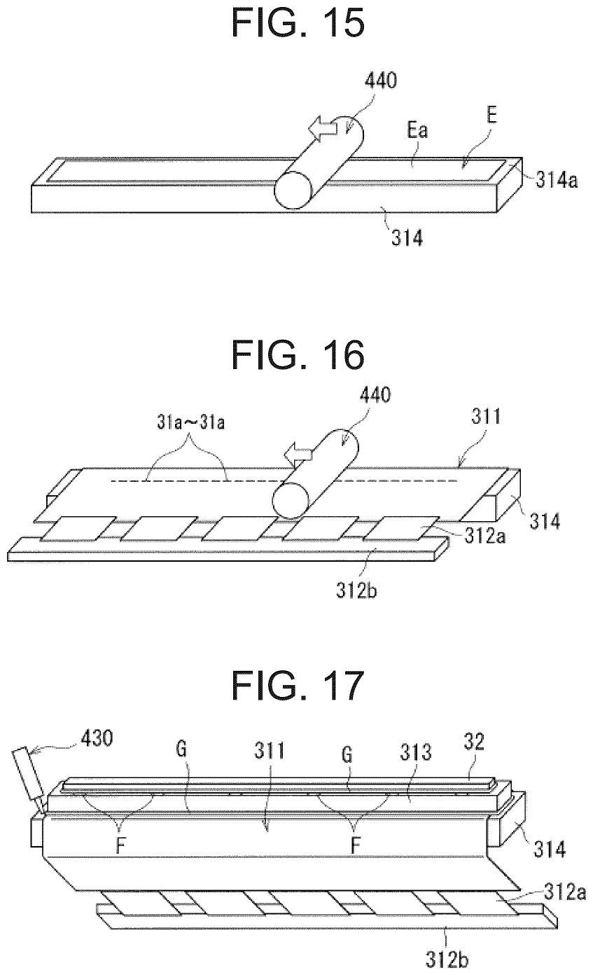

Subsequently, as shown in FIG. 15, a double-sided adhesive tape (E) (double-sided adhesive sheet) is attached to the surface (314a) of the fixing member 314 on the side to which the light-emitting element panel 311 is to be attached by using a roller pressure-bonding device 440 in a state where a protective seal Ea on one side is left attached (fourth process).

Subsequently, as shown in FIG. 16, the protective seal Ea on the one side of the double-sided adhesive tape (E) is peeled off, and in a state where the plurality of light-emitting elements 31 to 31 in the light-emitting element panel 311 are positioned at the reference positioning positions of the fixing member 314, the light-emitting element panel 311 is bonded to the fixing member 314 by using the roller pressure-bonding device 440 (fifth process).

Subsequently, as shown in FIG. 17, the lens holding member 313 holding the lens array 32 manufactured in the third process (see FIG. 14) is placed on the light-emitting element panel 311 attached to the fixing member 314, and the caulking agent G (caulking resin) is applied to the peripheral region between the lens holding member 313 and the light-emitting element panel 311 using the caulking-agent application device 430 so as to seal the gap between the lens holding member 313 and the light-emitting element panel 311 (sixth process). As a result, entry of a foreign substance such as dust through a gap between the lens holding member 313 and the light-emitting element panel 311 can be prevented.

### This Embodiment

The print head 3 according to this Embodiment includes, as shown in FIG. 9 to FIG. 11, the film-like light-emitting element panel 311 having the plurality of light-emitting elements 31 to 31 aligned in a line state, the lens array 32 that collects light emitted from the plurality of light-emitting elements 31 to 31 onto the photosensitive drum 1 (an example of the image carrier), and the fixing member 314 that fixes the light-emitting element panel 311. The fixing member 314 is constituted by a resin material.

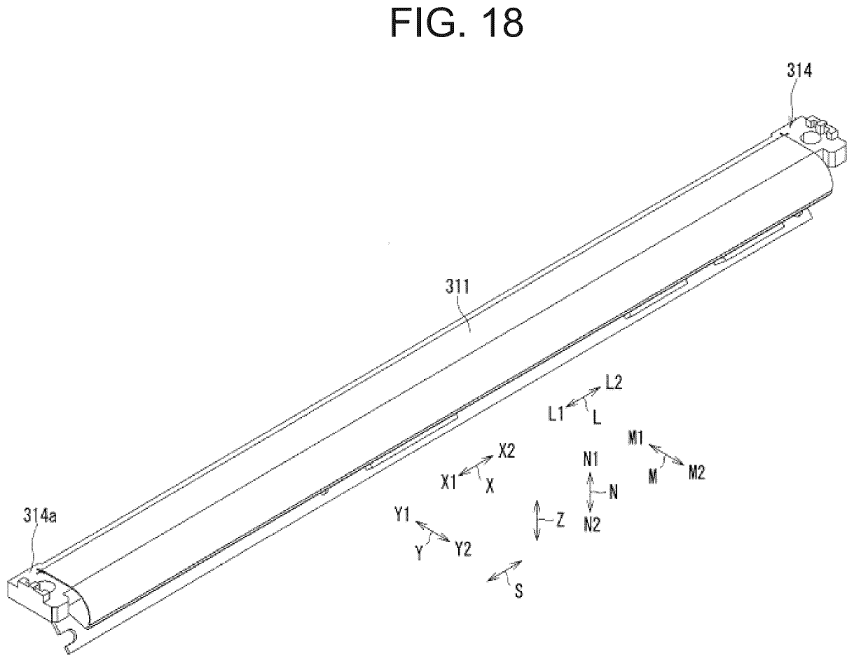

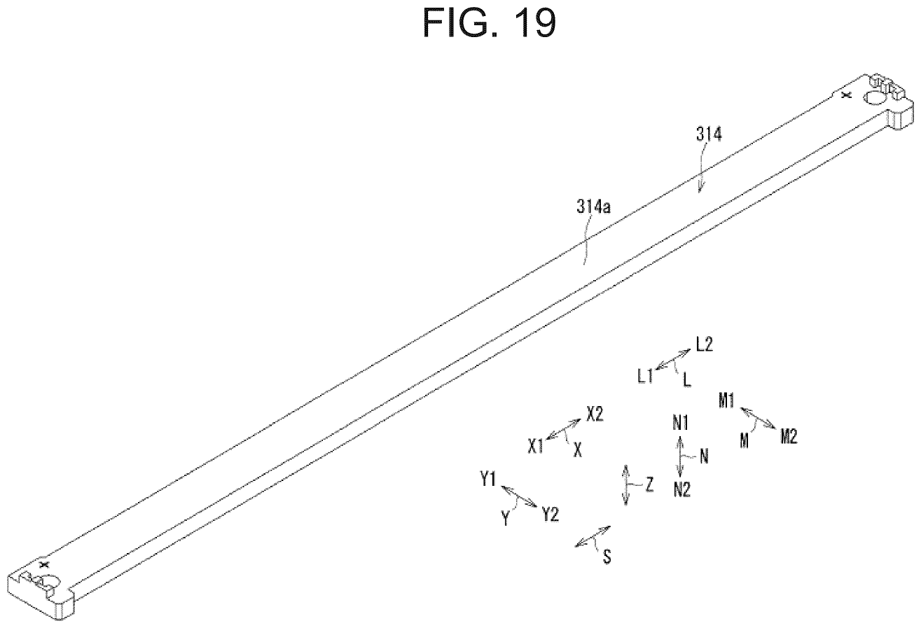

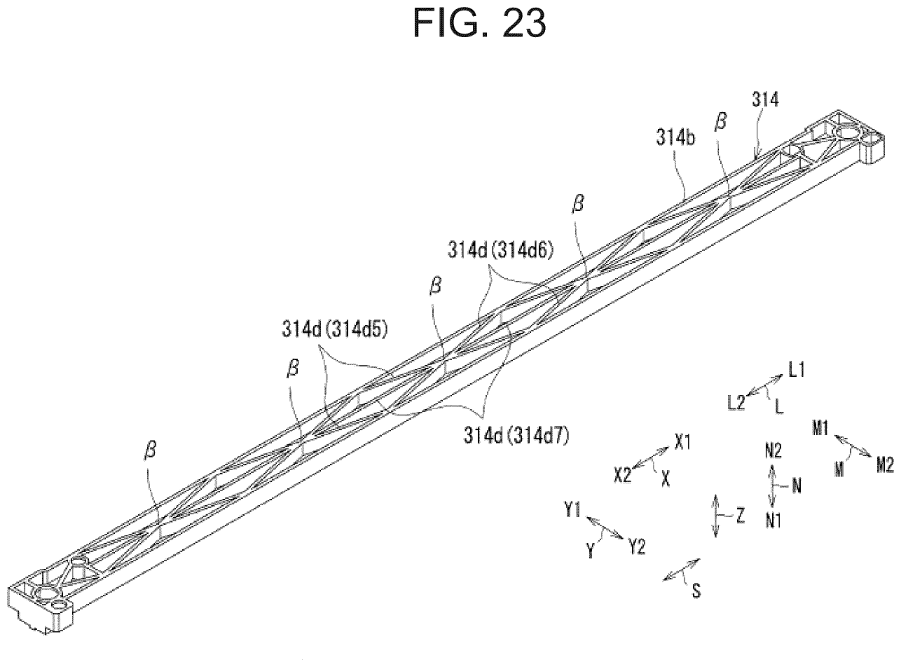

FIG. 18 is a perspective view illustrating a state in which the light-emitting element panel 311 is provided on the fixing member 314. FIG. 19 is a perspective view illustrating the fixing member 314. FIG. 20 to FIG. 23 are perspective views illustrating a rib 314d of a first aspect, a second aspect, a third aspect, and a fourth aspect provided on the rear surface 314b of the fixing member 314, respectively. Note that the rib on the rear surface 314b of the fixing member 314 shown in FIG. 7 represents the fourth aspect shown in FIG. 23.

The rib 314d (see FIG. 20 to FIG. 23) is provided on a surface (rear surface 314b) of the fixing member 314 on a side opposite to the light-emitting element panel 311 side.

The rib 314d of the first aspect shown in FIG. 20 extends along the alignment direction S (longitudinal direction L) to outward than the plurality of light-emitting elements 31 to 31 and includes a plurality of rows (two rows in this example) of the ribs 314d1, 314d2 provided in parallel in the width direction M.

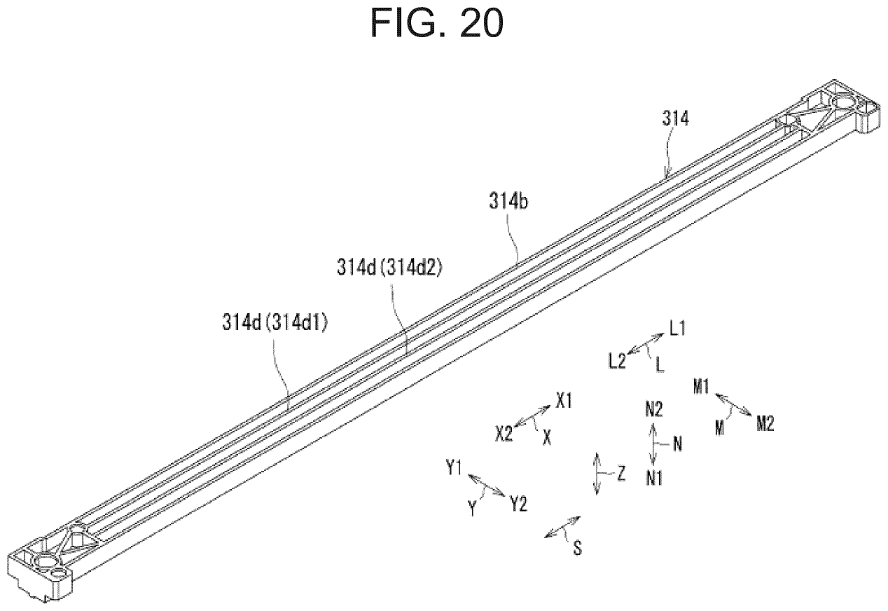

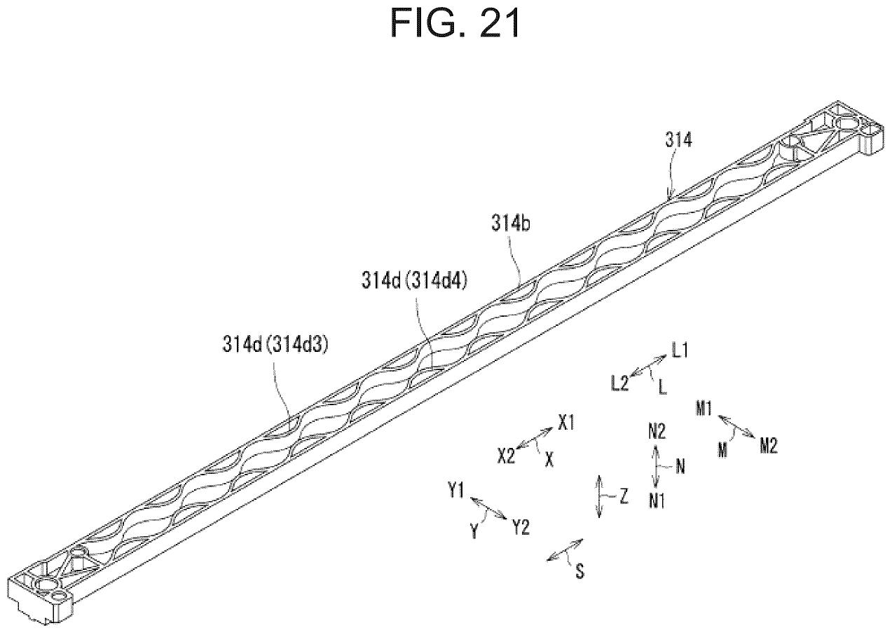

The rib 314d of the second aspect illustrated in FIG. 21 includes ribs 314d3 and 314d4 formed in a circular wave shape in the alignment direction S on both sides in the width direction M.

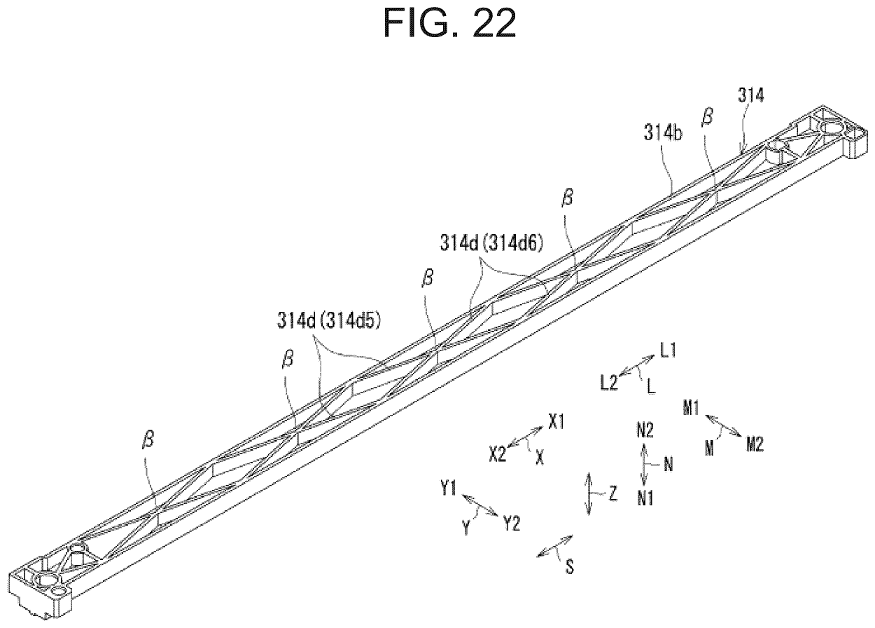

The rib 314d of the third aspect illustrated in FIG. 22 includes at least two (two in this example) ribs 314d5, 314d6, and the ribs 314d5, 314d6 extend in a direction intersecting the alignment direction S so as to intersect at the same inclination angle with the center in the width direction M of the fixing member 314 as intersections β to β, and a plurality of sets (five sets in this example) of the intersecting ribs 314d5, 314d6 are connected in the alignment direction S at both end parts in the width direction M.

The rib 314d of the fourth aspect illustrated in FIG. 23 further includes a rib 314d7 passing through the intersections β to β of the ribs 314d5, 314d5 and extending to both sides in the alignment direction S in the fixing member 314 shown in FIG. 22.

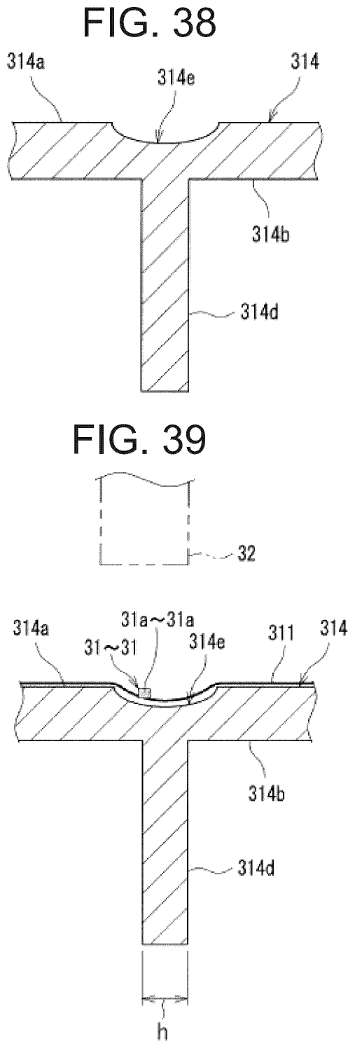

Incidentally, as described above, when the fixing member 314 is formed by a resin material, the fixing member 314 needs to have a certain degree of strength so as not to be deformed. Therefore, the strength is secured by providing the rib 314d on the surface (rear surface 314b) on the side opposite to the light-emitting element panel 311 side of the fixing member 314. However, as shown in FIG. 38, the displacement spot 314e (in particular, a sink mark due to a rib, called a recess) is generated by a rib shape at a spot corresponding to the rib 314d of a surface (front surface 314a) of the fixing member 314 on which the light-emitting element panel 311 is provided.

Since the film-like light-emitting element panel 311 according to this Embodiment is extremely thin and it is approximately 0.14 mm, for example, and is closely attached (bonded) to the fixing member 314, when a displacement spot 314e (particularly, a sink mark) is generated in the fixing member 314 due to the rib shape, the light-emitting element panel 311 is deformed (for example, waved) by the displacement spot 314e (see FIG. 39).

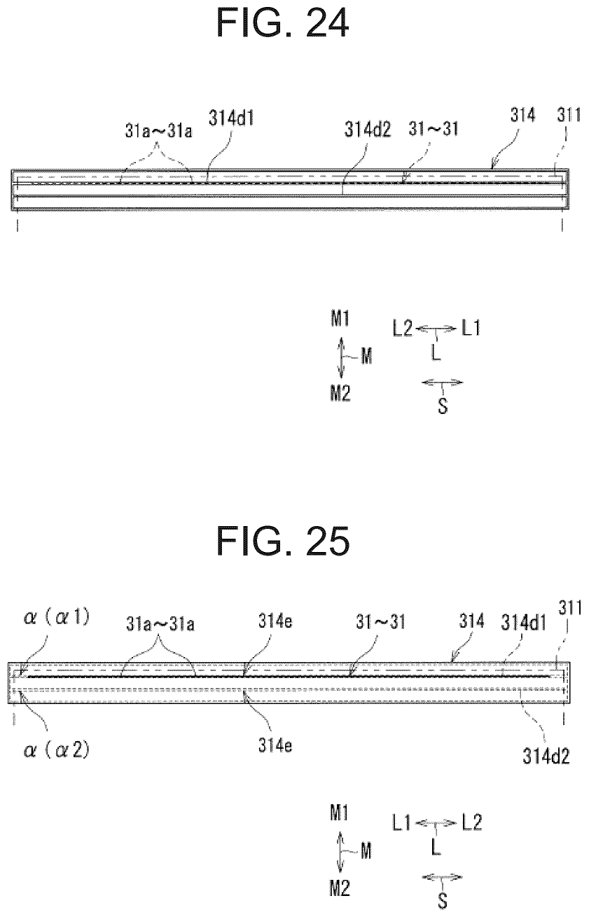

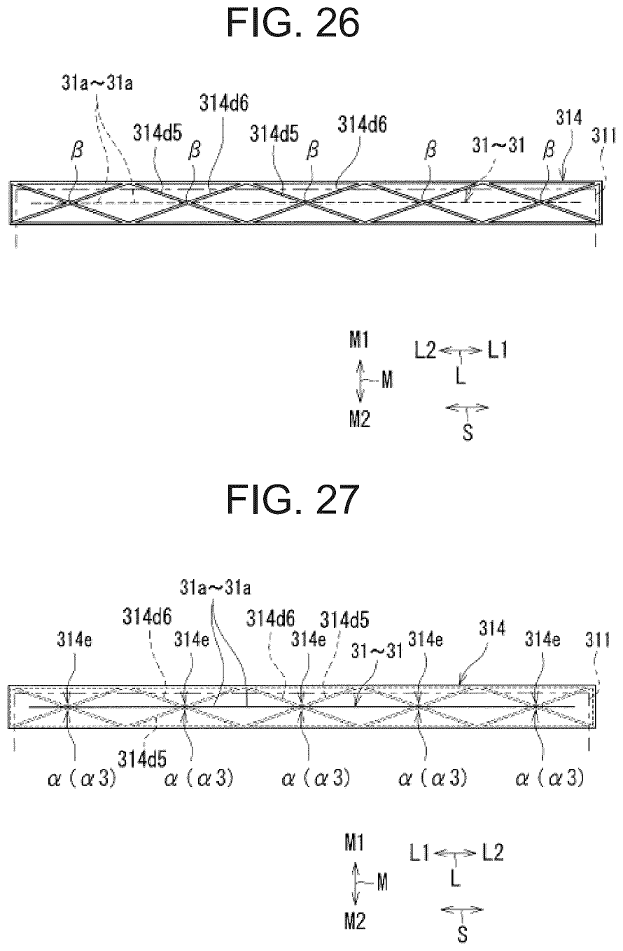

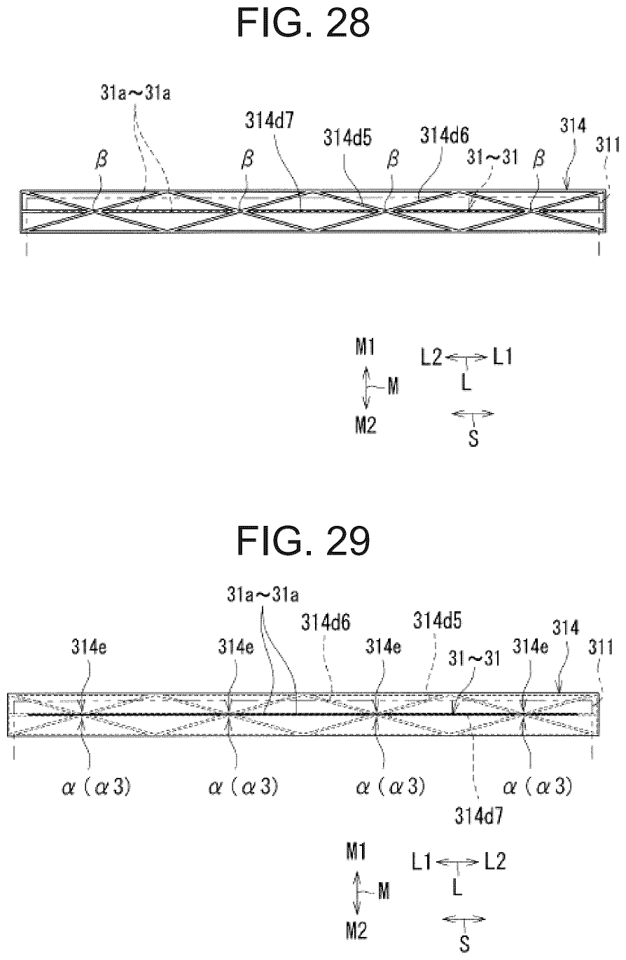

FIG. 24 and FIG. 25 are a plan view and a bottom view illustrating a positional relationship of a first comparative example of the ribs 314d1, 314d2 of the first aspect shown in FIG. 20 and the plurality of light-emitting elements 31 to 31, respectively. FIG. 26 and FIG. 27 are a plan view and a bottom view illustrating a positional relationship of a second comparative example of the ribs 314d5, 314d6 of the third aspect shown in FIG. 22 and the plurality of light-emitting elements 31 to 31, respectively. In addition, FIG. 28 and FIG. 29 are a plan view and a bottom view illustrating a positional relationship of a third comparative example of the ribs 314d5, 314d6, 314d7 of the fourth aspect shown in FIG. 23 and the plurality of light-emitting elements 31 to 31, respectively.

In the positional relationship of the first comparative example shown in FIG. 24 and FIG. 25, each of the light-emitting points 31a to 31a of the plurality of light-emitting elements 31 to 31 is provided in a spot corresponding to the displacement spot 314e in the light-emitting element panel 311. That is, each of the light-emitting points 31a to 31a overlaps the rib region α (α1 or α2, α1 in the illustrated example) corresponding to the ribs 314d1, 314d2, and the light-emitting element panel 311 is deformed by the displacement spot 314e.

In the positional relationship of the second comparative example shown in FIG. 26 and FIG. 27, a part of each of the light-emitting points 31a to 31a of the plurality of light-emitting elements 31 to 31 overlaps the rib region α (α3) corresponding to the intersections β to β of the ribs 314d5, 314d6, and the light-emitting element panel 311 is deformed by the displacement spots 314e to 314e corresponding to the intersections β to β.

In the positional relationship of the third comparative example shown in FIG. 28 and FIG. 29, the positional relationship of the first comparative example and the positional relationship of the second comparative example are combined. Therefore, a thicknesses h (see FIG. 39) of the intersections β to β is larger than the positional relationship of the first comparative example and the positional relationship of the second comparative example, and the displacement of the displacement spot 314e corresponding to the intersections β to β is increased accordingly and thus, the deformation of the light-emitting element panel 311 due to the displacement spot 314e is increased.

As described above, when the light-emitting element panel 311 is deformed by the displacement spot 314e, as shown in FIG. 39, the positional relationship between the lens array 32 and each of the light-emitting points 31a to 31a of the light-emitting elements 31 to 31 of the part corresponding to the displacement spot 314e in the light-emitting element panel 311 among the plurality of light-emitting elements 31 to 31 is collapsed (the focal distance with the lens array 32 is shifted), and such a spot where a spot cannot be allowed at each image height is generated. Therefore, when the surface 1a of the photosensitive drum 1 is irradiated with the light emitted by the plurality of light-emitting elements 31 to 31, inconvenience such as a defective beam diameter on the surface 1a of the photosensitive drum 1 or the like occurs.

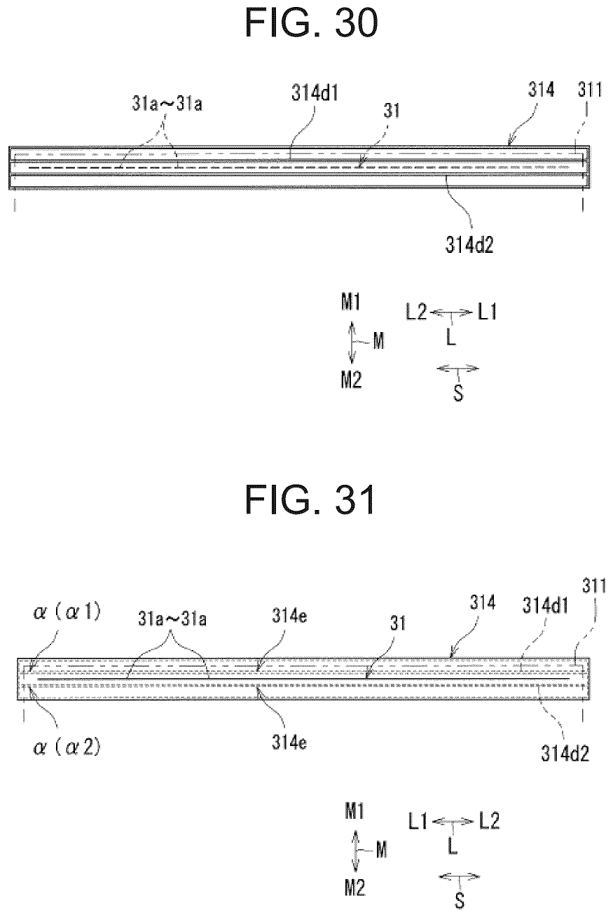

In this regard, this Embodiment has a constitution as follows. This will be explained below with reference to FIG. 30 to FIG. 34.

### First Embodiment

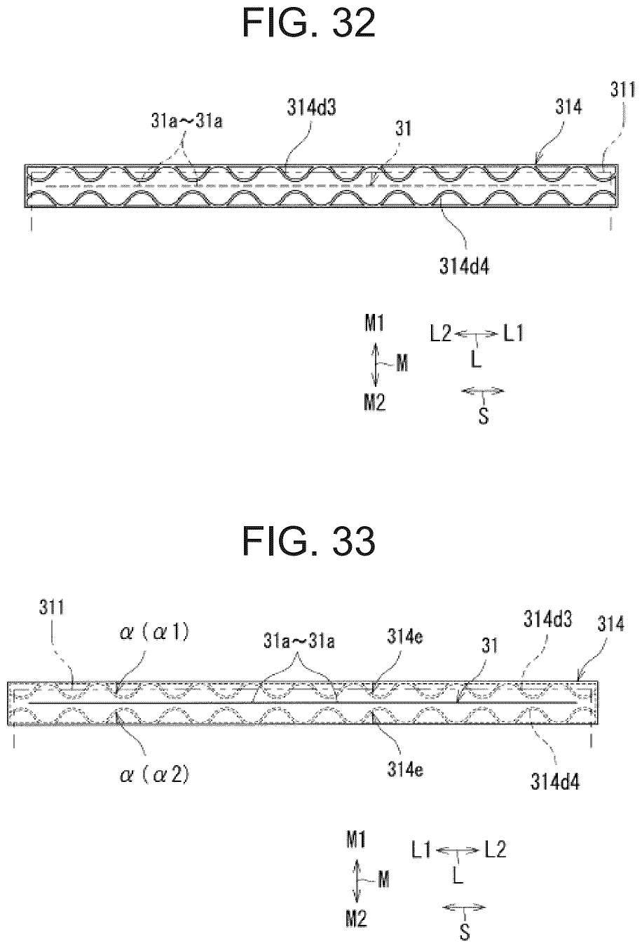

FIG. 30 and FIG. 31 are a plan view and a bottom view illustrating a positional relationship of the First Embodiment-1 between the ribs 314d1, 314d2 of the first aspect shown in FIG. 20 and the plurality of light-emitting elements 31 to 31, respectively. In addition, FIG. 32 and FIG. 33 are a plan view and a bottom view illustrating a positional relationship of the First Embodiment-2 between the ribs 314d3, 314d4 of the second aspect shown in FIG. 21 and the plurality of light-emitting elements 31 to 31, respectively.

In this Embodiment, the plurality of light-emitting elements 31 to 31 are provided on the light-emitting element panel 311 such that none of the light-emitting points 31a to 31a overlaps the rib regions α (α1, α2) corresponding to the ribs 314d (314d1, 314d2), (314d3, 314d4).

According to this Embodiment, even when the light-emitting element panel 311 is deformed (for example, waved) by the displacement spot 314e (particularly, a sink mark), the plurality of light-emitting elements 31 to 31 are provided on the light-emitting element panel 311 so that none of the light-emitting points 31a to 31a overlaps the rib region α (α1, α2) corresponding to the ribs 314d [(314d1, 314d2), (314d3, 314d4)]. Therefore, the positional relationship between the lens array 32 and each of the light-emitting points 31a to 31a of the plurality of light-emitting elements 31 to 31 can be maintained and thus, such a spot where the focus cannot be allowed at each image height can be reduced or eliminated. As a result, occurrence of the inconveniences such as defective beam diameters on the surface 1a of the photosensitive drum 1 or the like, when the surface 1a of the photosensitive drum 1 is irradiated with the light emitted from the plurality of light-emitting elements 31 to 31 can be effectively prevented.

### First Embodiment-1

Incidentally, when the rib 314d is inclined with respect to the alignment direction S along the line-state direction of the plurality of light-emitting elements 31 to 31, the lengths of the plurality of light-emitting elements 31 to 31 in the alignment direction S are limited so that none of the light-emitting points 31a to 31a of the plurality of light-emitting elements 31 to 31 overlaps the rib region α corresponding to the rib 314d, when the light-emitting element panel 311 is designed.

In this regard, in the First Embodiment-1 shown in FIG. 30 and FIG. 31, the ribs 314d1, 314d2 are formed linearly so as to extend in the alignment direction S of the plurality of light-emitting elements 31 to 31.

With this configuration, even when the lengths of the plurality of light-emitting elements 31 to 31 in the alignment direction S are made longer, none of the light-emitting points 31a to 31d of the plurality of light-emitting elements 31 to 31 can overlap the rib regions α1, α2 corresponding to the ribs 314d1, 314d2. As a result, the light-emitting element panel 311 can be designed without considering the limitation of the lengths of the plurality of light-emitting elements 31 to 31 in the alignment direction S.

### First Embodiment-2

In the First Embodiment-2 shown in FIG. 32 and FIG. 33, the ribs 314d3, 314d4 are formed in a circular wave shape or a triangular wave shape (circular wave shape in this example) toward the alignment direction S of the plurality of light-emitting elements 31 to 31.

In this configuration, by means of the ribs 314d3, 314d4 having a circular wave shape or a triangular wave shape, each of the light-emitting points 31a to 31a of the plurality of light-emitting elements 31 to 31 from overlapping the rib regions α1, α2 corresponding to the ribs 314d3, 314d4 in a state where the strength of the fixing member 314 is improved as compared with the ribs 314d1, 314d2 of the First Embodiment-1.

### First Embodiment-3

In the First Embodiment shown in FIG. 30 to FIG. 33, the rib 314d includes two or more (two in this example) ribs (314d1, 314d2), (314d3, 314d4) provided on both sides with the plurality of light-emitting elements 31 to 31 between them in the width direction M.

In detail, in the First Embodiment-1 shown in FIG. 30 and FIG. 31, the plurality of light-emitting elements 31 to 31 are provided between the two linear ribs 314d1, 314d2 in the width direction M (in this example, an intermediate spot). In addition, in the First Embodiment-2 shown in FIG. 32 and FIG. 33, the plurality of light-emitting elements 31 to 31 are provided between the two ribs 314d3, 314d4 having the circular wave shape or the triangular wave shape in the width direction M (in this example, the intermediate spot). Note that the ribs (314d1, 314d2) of the First Embodiment-1 and the ribs (314d3, 314d4) of the First Embodiment-1 may be combined.

With this configuration, the two or more ribs (314d1, 314d2), (314d3, 314d4) provided on the both sides thereof with the plurality of light-emitting elements 31 to 31 in the width direction M therebetween can prevent each of the light-emitting points 31a to 31a of the plurality of light-emitting elements 31 to 31 from overlapping the rib regions (α1, α2) corresponding to the ribs (314d1, 314d2), (314d3, 314d4), while ensuring the strength of the fixing member 314 on both sides in the width direction M.

### First Embodiment-4

Incidentally, the depth of the displacement spot 314e on the surface of the fixing member 314 on which the light-emitting element panel 311 is provided decreases as the distance from the displacement spot 314e increases. For example, when separating from a region larger than the thickness h of the rib 314d (see FIG. 39) by 4 times, the deformation of the light-emitting element panel 311 can be effectively prevented. Here, the “region larger than the thickness h of the rib 314d by 4 times” is a region larger than the maximum thickness h from the center of the maximum thickness h of the rib 314d by within 4 times.

In this regard, in this Embodiment, the plurality of light-emitting elements 31 to 31 are provided so as to be located in a region other than the region with the thickness h of the rib 314d larger by 4 times.

In this way, the deformation of the light-emitting element panel 311 can be effectively prevented and thus, the positional relationship between the lens array 32 and each of the light-emitting points 31a to 31a of the plurality of light-emitting elements 31 to 31 can be maintained and further, such a spot where the focus cannot be allowed at each image height can be eliminated.

### Second Embodiment

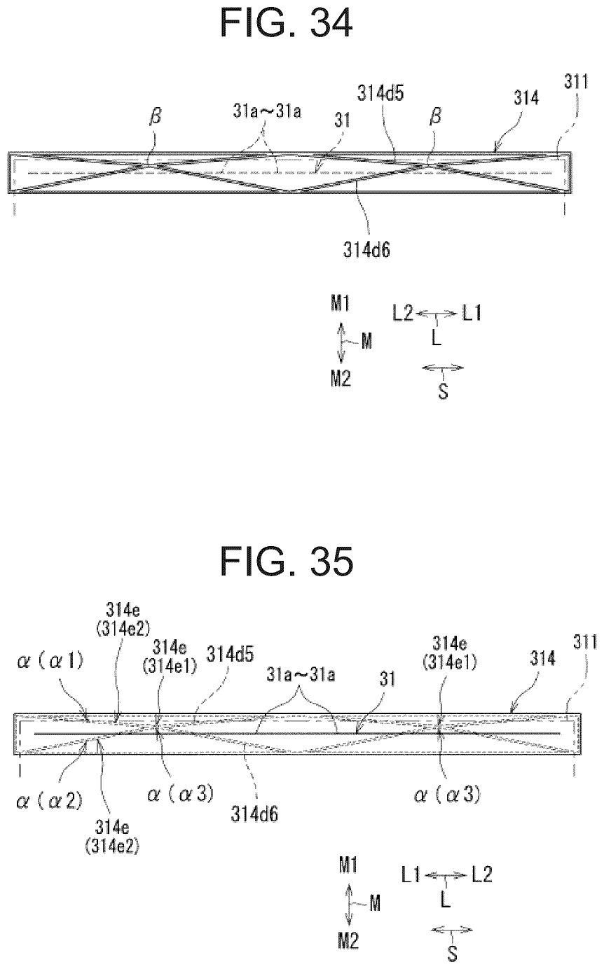

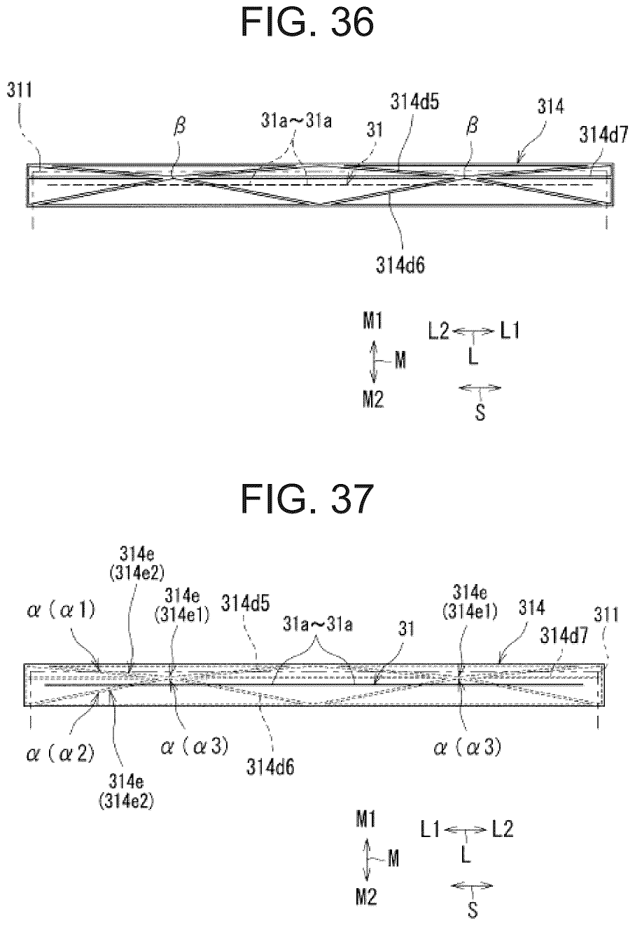

FIG. 34 and FIG. 35 are a plan view and a bottom view, respectively, illustrating the positional relationship between the ribs 314d5, 314d6 and the plurality of light-emitting elements 31 to 31 according to the Second Embodiment-1, in which the positions of the intersections β to β are shifted to either one of the sides in the width direction M in the third aspect shown in FIG. 22. In addition, FIG. 36 and FIG. 37 are a plan view and a bottom view, respectively, illustrating the positional relationship between the ribs 314d5, 314d6, and 314d7 and the plurality of light-emitting elements 31 to 31 in the Second Embodiment-2 in which the positions of the intersections β to β are shifted to either one of the sides in the width direction M in the fourth aspect shown in FIG. 23.

In the Second Embodiment-1 shown in FIG. 34 and FIG. 35, the rib 314d5 and the rib 314d6 extend in a direction intersecting the width direction M, and the intersections β to β between the rib 314d5 and the rib 314d6 are shifted to either one of the sides (in this example, the one side M1) in the width direction M. In addition, in the Second Embodiment-2 shown in FIG. 36 and FIG. 33, in the Second Embodiment-1, the rib 314d7 passes through the intersections β to β of the rib 314d5 and the rib 314d6 and extends along the alignment direction S to the outer side of the plurality of light-emitting elements 31 to 31.

In this Embodiment, at least two ribs (two ribs 314d5, 314d6 in the Second Embodiment-1 and three ribs 314d5, 314d6, 314d7 in the Second embodiment-2) are provided so as to intersect each other on the surface (rear surface 314b) of the fixing member 314 on the side opposite to the light-emitting element panel 311 side.

Incidentally, the depth of the displacement spot 314e (314e1) in an intersection region α3 corresponding to the intersections β to β where at least two ribs intersect becomes deeper than the depth of the displacement spot 314e (314e2) in the rib regions (α1, α2) other than the intersection region α3. In this case, even if the deviation of the focal distance can be allowed in the area corresponding to the displacement spot 314e2 of the rib regions (α1, α2) other than the intersection region α3 of the light-emitting element panel 311, the deviation of the focal distance cannot be allowed in the area corresponding to the displacement spot 314e1 in the intersection region α3 in some cases.

In this regard, the plurality of light-emitting elements 31 to 31 are provided on the light-emitting element panel 311 such that each of the light-emitting points 31a to 31a does not overlap the intersection region ◯corresponding to the intersections β to β where at least two ribs (314d5, 314d6), (314d5, 314d6, 314d7) intersect each other.

According to this Embodiment, even if the light-emitting element panel 311 is deformed by the displacement spot 314e (314e1, 314e2), the plurality of elements 31 to 31 are provided on the light-emitting element panel 311 such that none of the light-emitting points 31a to 31a of the plurality of light-emitting elements 31 to 31 overlaps the intersection region α3 corresponding to the intersections β to β where at least two ribs (314d5, 314d6), (314d5, 314d6, 314d7) intersect each other. Therefore, in regions other than the rib regions α (α1 to α3) corresponding to the ribs (314d5, 314d6), (314d5, 314d6, 314d7) of the light-emitting element panel 311, the positional relationship between the lens array 32 and each of the light-emitting points 31a to 31a of the plurality of light-emitting elements 31 to 31 can be maintained and thus, such a spot where the focus cannot be allowed at each image height can be reduced or eliminated. As a result, occurrence of the inconveniences such as defective beam diameters on the surface 1a of the photosensitive drum 1 or the like, when the surface 1a of the photosensitive drum 1 is irradiated with the light emitted from the plurality of light-emitting elements 31 to 31 can be effectively prevented. In addition, the deviation of the focal distance can be allowed in the area corresponding to the displacement spot 314e2 of the rib regions (α1, α2) other than the intersection region α3 of the light-emitting element panel 311 and thus, such a spot where the focus cannot be allowed at each image spot can be reduced or eliminated. As a result, occurrence of the inconveniences such as defective beam diameters on the surface 1a of the photosensitive drum 1 or the like, when the surface 1a of the photosensitive drum 1 is irradiated with the light emitted from the plurality of light-emitting elements 31 to 31 can be effectively prevented.

### Second Embodiment-1

Incidentally, if at least two ribs (314d5, 314d6), (314d5, 314d6, 314d7) include an inclined rib (314d5, 314d6) inclined with respect to the alignment direction S of the plurality of light-emitting elements 31 to 31, the lengths of the plurality of light-emitting elements 31 to 31 in the alignment direction S are limited in order to design the light-emitting element panel 311 such that none of the light-emitting points 31a to 31a of the plurality of light-emitting elements 31 to 31 overlaps the rib regions α (α1 to α3) corresponding to the ribs (314d5, 314d6), (314d5, 314d6, 314d7).

In this regard, in this Embodiment, the plurality of light-emitting elements 31 to 31 are provided in the light-emitting element panel 311 such that some of the light-emitting points 31a to 31a overlaps the inclined rib regions (α1 and α2) other than the intersection region α3 among the inclined rib regions (α1 to α3) corresponding to the inclined ribs (314d5, 314d6).

With this configuration, even if the lengths of the plurality of light-emitting elements 31 to 31 in the alignment direction S are increased, the light-emitting points 31a to 31a of the plurality of light-emitting elements 31 to 31 can be made to partially overlap the inclined rib regions (α1, α2) other than the intersection region α3 among the inclined rib regions (α1 to α3). As a result, the deviation of the focal distance in the area corresponding to the displacement spot 314e2 of the inclined rib regions (α1, α2) other than the intersection region α3 of the light-emitting element panel 311 and thus, such a spot where the focus cannot be allowed at each image height can be reduced or eliminated.

In the example shown in FIG. 36 and FIG. 37, an alignment-direction rib (314d7) along the alignment direction S of the plurality of light-emitting elements 31 to 31 is further provided on the surface (rear surface 314b) of the fixing member 314 on the side opposite to the light-emitting element panel 311 side. The alignment-direction rib (314d7) intersects with the inclined ribs (314d5, 314d6) at the intersections β to β.

### Second Embodiment-2

In the example shown in FIG. 34 to FIG. 37, the intersections β to β are located on either one of sides (in this example, one side M1) of the fixing member 314 in the width direction M of the plurality of light-emitting elements 31 to 31. The plurality of light-emitting elements 31 to 31 are provided such that each light-emitting point is located on the other side (center side) of the intersections β to β of the fixing member 314 in the width direction M.

In this way, the plurality of light-emitting elements 31 to 31 can be provided closer to the center side (the center position in this example) than the intersections β to β in the width direction M of the fixing member 314.

Note that, in the example shown in FIG. 34 to FIG. 37, the intersections β to β may be positioned at the center of the fixing member 314 in the width direction M. In this case, the plurality of light-emitting elements 31 to 31 can be provided on either one of the sides in the width direction M of the fixing member 314.

### Third Embodiment

Incidentally, as the resin material used for the fixing member 314, a resin material (for example, a liquid crystal polymer), which is excellent in strength, deformation resistance, rigidity, and heat resistance and in which the displacement spot 314e (particularly, a sink mark) is unlikely to occur can be exemplified.

In this way, the fixing member 314 can be made of a plastic material (in this example, a material liquid crystal polymer), which is less likely to cause the displacement spot 314e to be generated, only with which the positional relationship between the lens array 32 and each of the light-emitting points 31a to 31a of the plurality of light-emitting elements 31 to 31 can be maintained, and such a spot where the focus cannot be allowed at each image height can be reduced or eliminated.

### Third Embodiment-1

In this Embodiment, a surface (front face 314a) of the fixing member 314 in a region where the light-emitting element panel 311 is provided does not have a protrusion (is flat). A height difference of unevenness of the surface (314a) of the region of the fixing member 314 where the light-emitting element panel 311 is provided may be, for example, equal to or less than a focal depth of the lens array 32.

With this configuration, since the surface (314a) of the region of the fixing member 314 where the light-emitting element panel 311 is provided does not have a protrusion (is a flat surface) provided, the positional relationship between the lens array 32 and each of the light-emitting points 31a to 31a of the plurality of light-emitting elements 31 to 31 can be maintained and thus, such a spot where the focus cannot be allowed at each image height can be reduced or eliminated.

This disclosure is not limited to the embodiments described above but can be implemented in various other forms. Therefore, the embodiments are merely exemplifications in all respects and should not be interpreted in a limited manner. The scope of this disclosure is defined by the scope of claims and is not limited by the description of the specification at all. In addition, all variations and changes belonging to the equivalent scope of the claims are within the scope of this disclosure.

What is claimed is:

1. A print head comprising: a film-like light-emitting element panel having a plurality of light-emitting elements aligned in a line state; a lens array that collects light emitted from the plurality of light-emitting elements onto an image carrier; and a fixing member that fixes the light-emitting element panel, wherein
the fixing member is constituted by a resin material;
a rib is provided on a surface on a side opposite to the light-emitting element panel side of the fixing member; and
the plurality of light-emitting elements are provided on the light-emitting element panel such that none of respective light-emitting points overlaps a rib region corresponding to the rib.

2. The print head according to claim 1, wherein
the rib is formed linearly so as to extend in an alignment direction along the line-state direction of the plurality of light-emitting elements.

3. The print head according to claim 1, wherein
the rib is formed in a circular wave shape or a triangular wave shape toward an alignment direction along the line-state direction of the plurality of light-emitting elements.

4. The print head according to claim 1, wherein
the ribs include two or more ribs provided on both sides thereof with the plurality of light-emitting elements therebetween in a width direction orthogonal to an alignment direction along the line-state direction of the plurality of light-emitting elements.

5. The print head according to claim 1, wherein
the plurality of light-emitting elements are provided so as to be positioned in a region other than a region four times a width of the rib.

6. A print head comprising: a film-like light-emitting element panel having a plurality of light-emitting elements aligned in a line state; a lens array that collects light emitted from the plurality of light-emitting elements onto an image carrier; and a fixing member that fixes the light-emitting element panel, wherein
the fixing member is constituted by a resin material;
at least two ribs are provided on a surface on a side opposite to the light-emitting element panel side of the fixing member so as to intersect each other; and
the plurality of light-emitting elements are provided on the light-emitting element panel such that none of respective light-emitting points overlaps an intersection region corresponding to an intersection where the at least two ribs intersect each other.

7. The print head according to claim 6, wherein
the at least two ribs include an inclined rib inclined with respect to the alignment direction along the line-state direction of the plurality of light-emitting elements; and
the plurality of light-emitting elements are provided on the light-emitting element panel such that a part of each of the light-emitting points overlaps an inclined rib region other than the intersection region among the inclined rib regions corresponding to the inclined ribs.

8. The print head according to claim 6, wherein
the intersection is located on either one of sides of the fixing member in a width direction orthogonal to an alignment direction along the line-state direction; and
the plurality of light-emitting elements are provided such that each of the light-emitting points is positioned closer to the other side than the intersection of the fixing member in the width direction.

9. The print head according to claim 1, wherein
the resin material is a liquid crystal polymer.

10. The print head according to claim 1, wherein
no protrusion is provided on a surface of a region where the light-emitting element panel of the fixing member is provided.

11. An image forming apparatus comprising the print head according to claim 1.
